(19) United States
(12) Patent Application Publication
(10) Pub. No.: US 2011/0223028 A1
(43) Pub. Date: Sep. 15, 2011

(54) Arrangement and method to retrofit a wind turbine

(76) Inventors: Jason Stege, Brande (DK); Henrik Stiesdal, Odense C (DK); Martin Winther-Jensen, Haslev (DK)

(21) Appl. No.: 13/039,370

(22) Filed: Mar. 3, 2011

(30) Foreign Application Priority Data
Mar. 12, 2010 (EP) 10156339.3

(51) Int. Cl. F03D 1/06; B23P 15/04

(52) U.S. Cl. 416/223 R; 29/889.7

(57) ABSTRACT

A blade of the wind turbine is prepared to be connected with the hub of the wind turbine. An extension unit is designed and prepared to elongate the blade. The extension unit is connected with the tip of the blade by a pressure, which is applied between the tip of the blade and the extension unit. The applied pressure is a low-pressure in relation to the ambient barometric pressure.

### CROSS REFERENCE TO RELATED APPLICATIONS

This application claims priority of European Patent Office application No. 10156339.3 EP filed Mar. 12, 2010, which is incorporated by reference herein in its entirety.

### FIELD OF INVENTION

The invention relates to an arrangement and to a method to retrofit a wind turbine.

### BACKGROUND OF INVENTION

Sometimes it is necessary to retrofit an existing and already mounted wind turbine to adjust its capability to the environmental conditions.

For example blades of the wind turbine may be dismantled from its hub and may be brought to the ground. A set of new blades, which may be longer than the old set of blades, may be installed at the hub to adjust the whole wind turbine.

The blades dismantled might be repaired or even reviewed for further use.

### SUMMARY OF INVENTION

This kind of retrofit-work is time expensive and costly. Especially the needed work is expensive for offshore wind turbines as the work needs to be done at calm weather-conditions. Additionally special designed vessels with cranes are needed to dismantle and to install the blades.

It is therefore the aim of the invention to provide an arrangement and a method, which allows the retrofit of a wind turbine in an easy, time- and cost-efficient way.

This aim is reached by the features of the independent claims.

Preferred embodiments of the invention are subject of the dependent claims.

According to the invention a wind turbine is retrofitted. For this purpose a blade of the wind turbine is prepared to be connected with the hub of the wind turbine. An extension unit is designed and prepared to elongate the blade. The extension unit is connected with the tip of the blade by a pressure, which is applied between the tip of the blade and the extension unit. The applied pressure is a low-pressure in relation to the barometric pressure of the wind turbine site.

In a preferred embodiment the blade is connected and stays connected with the hub during the retrofit-work. The retrofit work can be done on the site of the wind turbine very easily.

In a preferred embodiment the extension unit is a blade tip extender or a so called “winglet”.

The invention allows the retrofit of the blade without further attachment, at the site of the wind turbine or even asides a factory.

Any finishing work can be completed immediately after attachment ensuring a quick mounting process

According to the invention a quick attachment and alignment of the extension unit is allowed.

The preferably used technical vacuum allows an one-step mounting process.

The invention does not incur that costs, which were needed according to the prior art to dismount the blade from the hub or rotor.

In a preferred embodiment a soft seal or an oversized seal is used to ensure the low pressure into the cavity. Thus the initial positioning of the extension unit does not need to be too precise. A matching surface for the structure inside the extension unit is used guide the extension unit into its correct position.

The extension unit may be formed as a winglet tip, as a blade tip extension, as a blade tip lightening receptor, as a blade “shoulder” trailing edge extension, or the like.

### BRIEF DESCRIPTION OF THE DRAWINGS

The invention is shown in more detail by help of figures.

FIG. 1 shows a first embodiment of the invention, while

FIG. 2 shows a second embodiment of the invention.

### DETAILED DESCRIPTION OF INVENTION

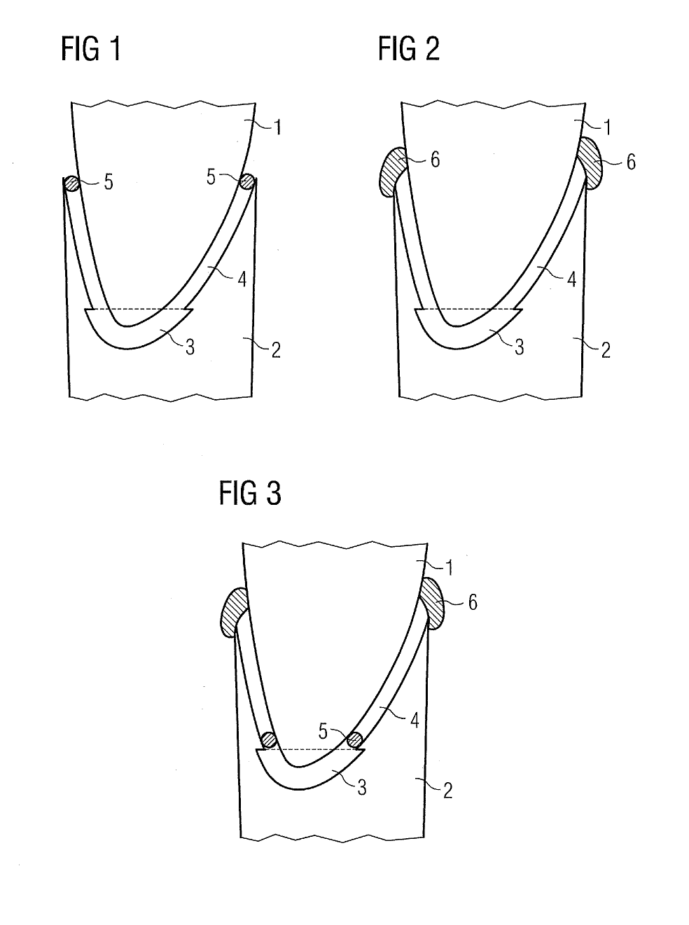

Referring to FIG. 1 a blade 1 is prepared to be connected with a hub of a wind turbine (not shown here).

An extension unit 2 is designed and prepared to elongate the blade 1.

The extension unit 2 is connected with the tip of the blade l by a pressure, which is applied between the tip of the blade 1 and the extension unit 2.

This applied pressure is a low-pressure in relation to the ambient barometric pressure.

More specific the applied pressure may be a technical vacuum.

The pressure may be applied to a cavity 3, which is formed between the inner surface of the extension unit 2 and the outer surface of the tip of the blade 1.

In a preferred embodiment an internal seal 5 is provided and is used between the extension unit 2 and the blade 1. This internal seal 5 enables to keep and to maintain the applied pressure within the cavity 3.

Referring to FIG. 2 an external seal 6 is used to maintain the applied pressure. The external seal 6 is connected to the outside of the extension unit 2, while the seal is provided as a so called “quick seal”.

Referring to FIG. 1 and to FIG. 2 the extension unit 2 is manoeuvred onto the tip of the blade 1. The applied pressure (technical vacuum) ensures that the extension unit 2 stays in place.

If a technical vacuum is applied with a tight seal 5 or 6, the extension unit 2 will stay in place without the need for additional external attachments.

Referring to both figures an adhesive can be applied to the extension part. Thus the clamping force will provide a tight bond at a glue area 4 between the tip of the blade 1 and the extension unit 2.

The applied vacuum provides an even clamping force and will create a better bond between the used materials.

Accordingly an internal seal 5 and an external seal 6 are both present to keep and maintain the used applied pressure. Thus the low-pressure (or the technical vacuum) can be applied in a separate cavity.

Additionally the seals are used that the adhesive, which is present in the glue area 4, does not overflow the edges of the extension unit 2.

Due to the applied low-pressure or the technical vacuum it is possible to use a wide range of commercial and even cheap adhesives. Their adhesion-effect is supported by the applied pressure.

In another embodiment of the invention the applied low-pressure or technical vacuum is used within a resin infusion process to distribute the adhesive in an even manner.

In another embodiment of the invention the tip-extension unit 2 is provided with a further vacuum cup 3. This cup 3 may be used to ensure that surplus adhesive is collected there.

Additionally the cup 3 allows that the position of the extension shows some freedom for the adjustment of its position.

1.-15. (canceled)

16. An arrangement to retrofit a wind turbine,
a blade of the wind turbine which is connected to the wind turbine; and
an extension unit adapted to elongate a blade of the wind turbine is connected with a tip of the blade by a pressure, which is applied between the tip of the blade and the extension unit,
wherein the applied pressure is a low-pressure in relation to the ambient barometric pressure,
whereby the blade is elongated without dismounting the blade from the wind turbine.

17. The arrangement according to claim 16, wherein the applied pressure is a technical vacuum.

18. The arrangement according to claim 16, wherein the extension unit contains an integrated cavity, which is constructed and designed to enclose at least a part of the tip of the blade.

19. The arrangement according to claim 18, wherein the cavity is constructed and designed in a way, that air is evacuated via an output to apply the pressure into the cavity.

20. The arrangement according to claim 16, wherein the extension unit is connected with the tip of the blade by the applied pressure only.

21. The arrangement according to claim 16, wherein a seal is placed between the extension unit and the at least part of the tip of the blade to ensure and maintain the applied pressure into the cavity.

22. The arrangement according to claim 16, wherein the blade is and stays connected with the hub of the wind turbine, while the retrofit is done.

23. The arrangement according to claim 16, wherein the applied pressure is a low-pressure in relation to the ambient barometric pressure of the wind turbine site.

24. A method to retrofit a wind turbine, comprising:
applying pressure between an extension unit to a tip of a blade of the wind turbine while the blade is connected to the wind turbine,
wherein the applied pressure is a low-pressure in relation to an ambient barometric,
whereby the blade is elongated without dismounting the blade from the wind turbine.

25. The method according to claim 24, wherein a technical vacuum is applied as pressure.

26. The method according to claim 24, wherein a cavity of the extension unit encloses at least a part of the tip of the blade, while the pressure is applied into the cavity.

27. The method according to claim 26, wherein air is evacuated via an output from the cavity to apply the pressure into the cavity.

28. The method according to claim 24, wherein the extension unit stays connected with the tip of the blade by the applied pressure only.

29. The method according to claim 24, wherein the blade stays connected with the hub of the wind turbine during the retrofit.

30. The method according to claim 24, wherein the applied pressure is a low-pressure in relation to the ambient barometric pressure of the wind turbine site.
